(19) United States
(12) Patent Application Publication
(10) Pub. No.: US 2014/0098138 A1
(43) Pub. Date: Apr. 10, 2014

(54) METHOD AND SYSTEM FOR AUGMENTED REALITY BASED SMART CLASSROOM ENVIRONMENT

(71) Applicant: Samsung Electronics Co., Ltd, Gyeonggi-do (KR)

(72) Inventors: Debi Prosad Dogra, West Bengal, IN (US); Saurabh Tyagi, Uttar Pradesh (IN); Trilochan Verma, Haryana (IN)

(73) Assignee: Samsung Electronics Co., Ltd, Gyeonggi-do (KR)

(21) Appl. No.: 14/047,921

(22) Filed: Oct. 7, 2013

(30) Foreign Application Priority Data
Oct. 5, 2012 (IN) 3116/DEL/2012
Jul. 26, 2013 (KR) 10-2013-0088954

(51) Int. Cl. G06T 19/00

(52) U.S. Cl. CPC G06T 19/006
USPC 345/633

(57) ABSTRACT

A method and system provide an augmented reality based environment using a portable electronic device. The method includes capturing an image of users, recognizing the users in the image, and fetching information associated with the recognized users. Further, the method includes determining location of the users in the image, mapping the fetched information associated with the users with the determined location of the users and communicating with the users based on the mapped information.

### CROSS-REFERENCE TO RELATED APPLICATION(S) AND CLAIM OF PRIORITY

The present application is related to and claims the benefit under 35 U.S.C. §119(a) a India patent application filed on Oct. 5, 2012 in the Indian Intellectual Property Office and assigned Serial No. 3116/DEL/2012 and of a Korean patent application filed on Jul. 26, 2013 in the Korean Intellectual Property Office and assigned Serial No. 10-2013-0088954, the entire disclosure of which is hereby incorporated by reference.

### TECHNICAL FIELD

The present disclosure relates to augmented reality environment, and more particularly to processing recognition information to provide interactive augmented reality based environment.

### BACKGROUND

Augmented Reality (AR) applications combine real world data and computer-generated data to create a user environment. The real world data may be collected using any data acquisition unit such as mobile phone, Personal Digital Assistant (PDA), smart phone, camera, communicator, wireless electronic device, or any other data acquisition unit. The augmented reality can be used in video games, Industrial designs, mapping, navigation, advertising, medical, visualization, military, emergency services, or in any other application. One of the most common approaches to the AR is the use of live or recorded videos/images, captured with a camera or mobile phone, which are processed and augmented with computer-generated data to provide an interactive augmented reality environment to the user. In many augmented reality applications, information about the surrounding real world of the user becomes interactive and digitally manipulated. In order to interact in an augmented reality environment, a user may need location information of other users in the virtual environment.

The present disclosure provides a smart and robust method and system for providing an interactive augmented reality based environment to a user.

### SUMMARY

To address the above-discussed deficiencies of the prior art, it is a primary object to provide a method and system for providing augmented reality environment using a portable electronic device.

Another object of the disclosure is to provide a method and system for processing recognition information to provide an augment reality environment to a user.

Another object of the disclosure is to provide a mechanism for providing an interactive augmented reality platform that allows users to interact with each other and digitally manipulate the information.

Another object of the disclosure is to provide a method and system for deriving location coordinates of users to provide an interactive user environment.

Accordingly the disclosure provides a method for providing augmented reality based environment using a portable electronic device. The method includes capturing an image of users, recognizing the users in the image, and fetching information associated with the recognized users. Further, the method includes determining location of the users in the image, mapping the fetched information associated with the users with the determined location of the users and communicating with the users based on the mapped information.

Furthermore, the method includes adjusting position of the portable electronic device according to position of the users. In an embodiment, the position of the portable electronic device is adjusted according to a predetermined region of the portable electronic device.

Furthermore, the method includes sending the image to a server for recognizing the users. In an embodiment, the server performs a facial recognition function on the image to determine face portion of the users and authenticate the determined face portion in the image to recognize the users.

Furthermore, the method includes transferring digital information to the users using the information and the determined location of the users. In an embodiment, the digital information is transferred by dragging and dropping the digital information in the determined location of the users.

Furthermore, the method includes performing an adaptive communication with the users based on the fetched information. Furthermore, the method includes using the information and the determined location of the users to take attendance in the environment.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates generally, among other things, a top view of a classroom, according to embodiments as disclosed herein;

FIG. 2 illustrates generally, among other things, an example of classroom environment, according to embodiments as disclosed herein;

FIG. 3 depicts an exemplary image of the classroom environment of the FIG. 2, according to embodiments as disclosed herein;

FIG. 4 illustrates generally, among other things, exemplary components of a system in which various embodiments of the present disclosure operates;

FIG. 5 illustrates generally, among other things, an exemplary predetermined region or field of view of the FIG. 2, according to embodiments as disclosed herein;

FIG. 6 illustrates a sequence diagram for operations performed by the system of the FIG. 4 using a server, according to embodiments as disclosed herein;

FIG. 7 illustrates a sequence diagram for operations performed by the system of the FIG. 4 without using the server, according to embodiments as disclosed herein;

FIG. 8 illustrates a flowchart of a method for providing augmented reality environment, according to embodiments as disclosed herein;

FIG. 9 illustrates a flowchart for operations performed by an instructor, according to embodiments as disclosed herein; and

FIG. 10 illustrates a computing environment capable of implementing the application, in accordance with various embodiments of the present disclosure.

### DETAILED DESCRIPTION

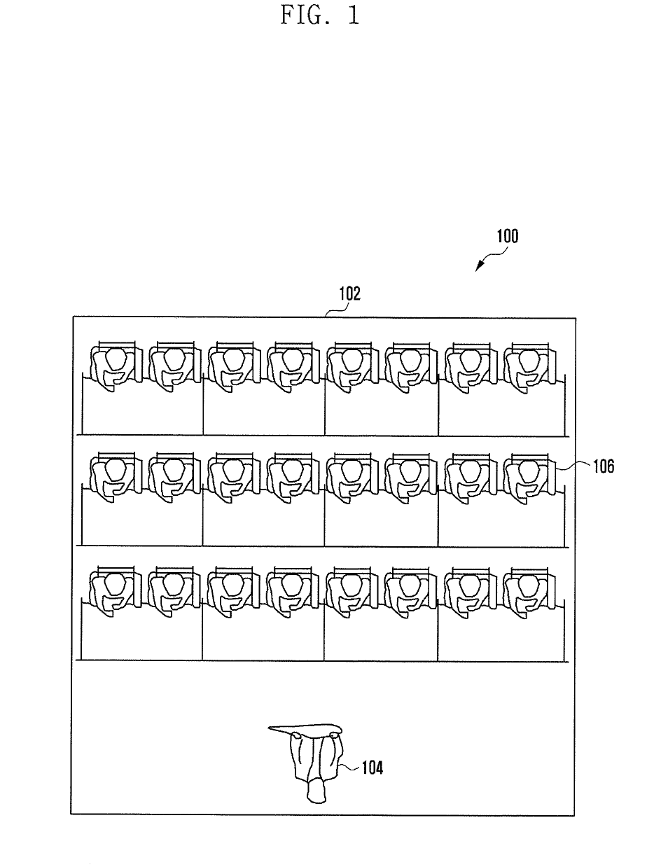

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for providing augmented reality based environment using a portable electronic device (hereinafter “PED”). The method allows an instructor to capture an image of audience using the PED. The instructor adjusts the position of the PED according to position of the audience. The instructor sends the captured image to a server for performing a facial recognition function to recognize the audience. The server recognizes the audience face(s) and fetches information associated with the recognized audience. Further, the server determines location coordinates of the audience and sends to the PED. The instructor maps the fetched information associated with the audience with the determined location of the audience. The instructor communicates with the audience based on the mapped information. Furthermore, the instructor performs an adaptive communication with the audience based on the fetched information.

The method and system disclosed herein is simple, robust, and reliable to provide an intelligent and smart augmented reality based environment. The method and system can be used to take attendance, interact, or perform any other activity inside a classroom, meeting room, or any other gathering. Further, the method and system provides an interactive platform to the instructor to easily interact and exchange digital information with the audience.

Referring now to the drawings, and more particularly to FIGS. 1 through 10, where similar reference characters denote corresponding features consistently throughout the figures, there are shown preferred embodiments.

Throughout the description, the term audience and one or more users is used interchangeably.

FIG. 1 illustrates generally, among other things, a top view 100 of a classroom 102, according to embodiments as disclosed herein. The classroom 102 can include an instructor 104 conducting a session with audience 106. The instructor 104 is standing or sitting in front of the audience 106 such that the instructor 104 is able to make direct eye-to-eye contact with the audience 106. In an embodiment, the instructor 104 described herein can be, for example, teacher, demonstrator, speaker, professor, presenter, guider, controller, or any other person. In an embodiment, the audience 106 described herein can be, for example, an individual or a group of students, users, participants, attendees, or any other person. The audience 106 can see, hear, and interact with the instructor 104 and among each other easily.

The classroom 102 described in the FIG. 1 is only for illustrative purpose and does not limit the scope of the disclosure. Further, in real type, the classroom 102 can be circular, square, rectangular, or in any other shape. Though the FIG. 1 is described with respect to a classroom but the present disclosure can be used in any type of gathering such as meeting, conferencing, social platform or environment, public or private event, company or organization workspace, or any other gathering.

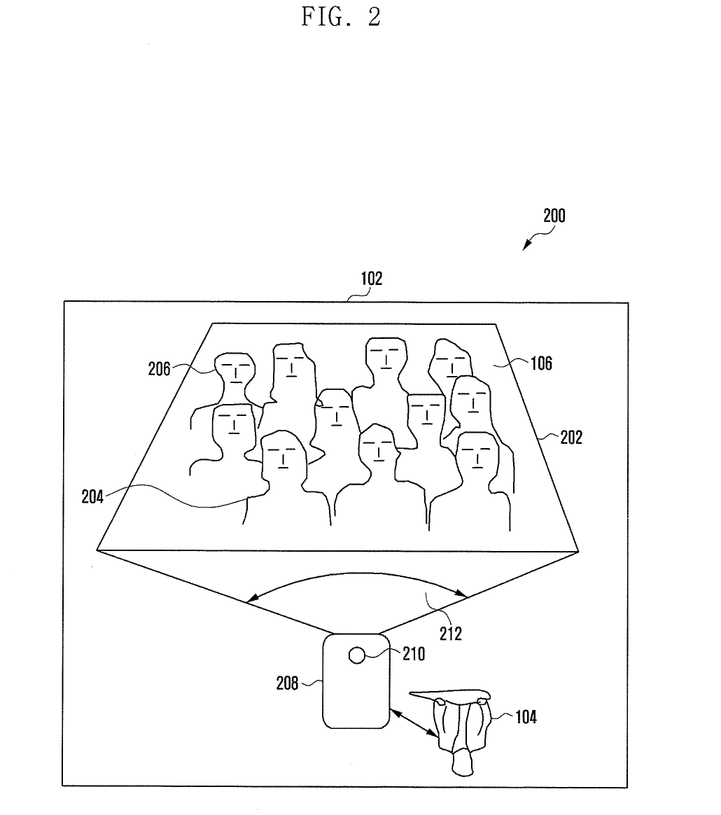

FIG. 2 illustrates generally, among other things, an example of classroom environment 200, according to embodiments as disclosed herein. In an embodiment, the classroom 102 includes audience 106 facing towards the instructor 104. The classroom 102 provides a room space 202 for sitting arrangement of the audience 106 as shown in the FIG. 2. In an example, a sequential setting arrangement of the audience 106 is made in which some of the audience appears to be close to the instructor 104 as shown at 204 and some of the audience 106 appears to be far from the instructor 104 as shown at 206.

In an embodiment, the instructor 104 can have a portable electronic device (PED) 208 to capture an image or video of the audience 106. The PED 208 described herein can include, for example, mobile phone, personal digital assistant, smart phone, tablet, or any other wireless customer electronic device. The PED 208 is capable of including imaging sensor 210 to capture single or multiple images or videos of the audience 106. In an embodiment, the instructor 104 can adjust the position of the PED 208 according to position of audience 106 such that the room space 202 is visible within a predetermined region 212 (or field of view 212) of the imaging sensor 210. The instructor 104 can adjust the position of the PED 208 according to the position of audience 106 such that face of every individual in the audience 106 can be clearly visible in the image. In an embodiment, the PED 208 can be a placed at any specific location of the classroom 102 in a way that the predetermined region 212 of the imaging sensor 210 covers the entire room space 202. The specific location described herein can provide a clear facial view of the audience 106 present in the classroom 102.

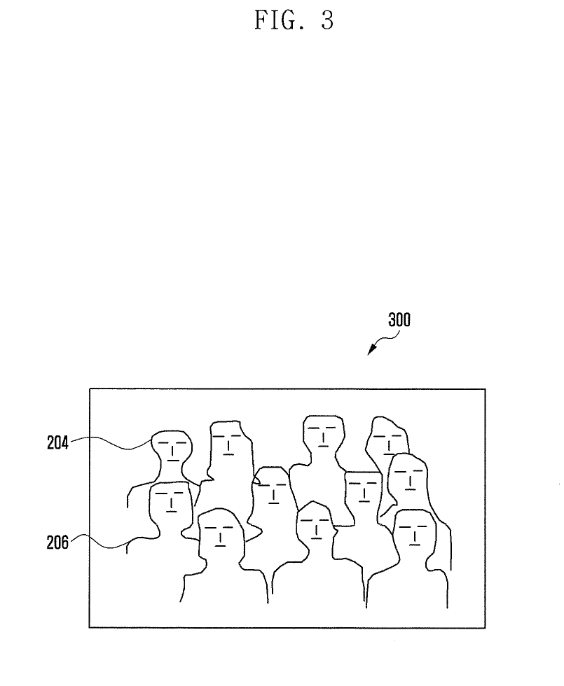

FIG. 3 illustrates an exemplary image 300 of the classroom environment 200 of the FIG. 2, according to embodiments as disclosed herein. The exemplary image 300 can be displayed on the display screen of the PED 102. In an embodiment, the image 300 can be viewed on any other display device, for example, liquid crystal display device, cathode ray tube monitor, plasma display, light-emitting diode (LED) display device, image projection device, or any other type of display device capable of presenting the image 300. The image 300 includes a scene having a visual representation of the audience 106, physical items, locality (for example, exact coordinates of where an individual user is currently located in the classroom 102), and other objects of the classroom 102.

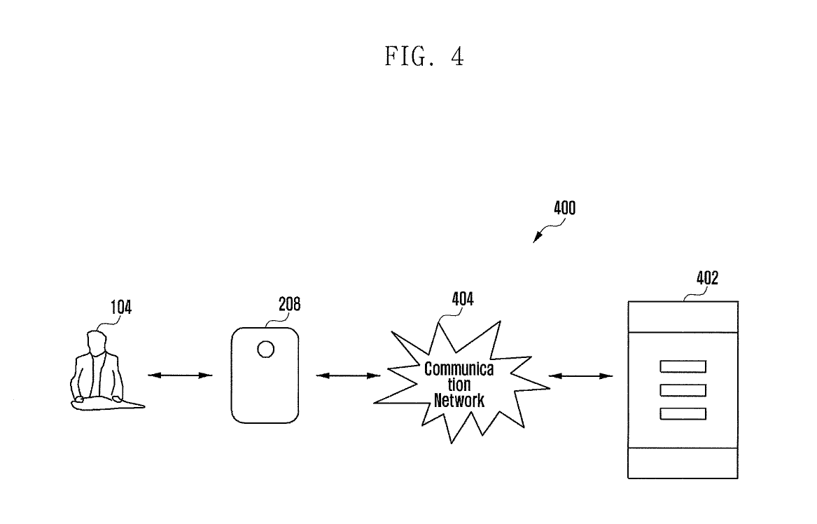

FIG. 4 illustrates generally, among other things, exemplary components of a system 400 in which various embodiment of the present disclosure operates. The system 400 can include a server 402 configured to be connected to the PED 208 through a wired or wireless communication network 404. In an embodiment, the instructor 104 can use the PED 208 to capture and send the image of the audience 106 to the server 402.

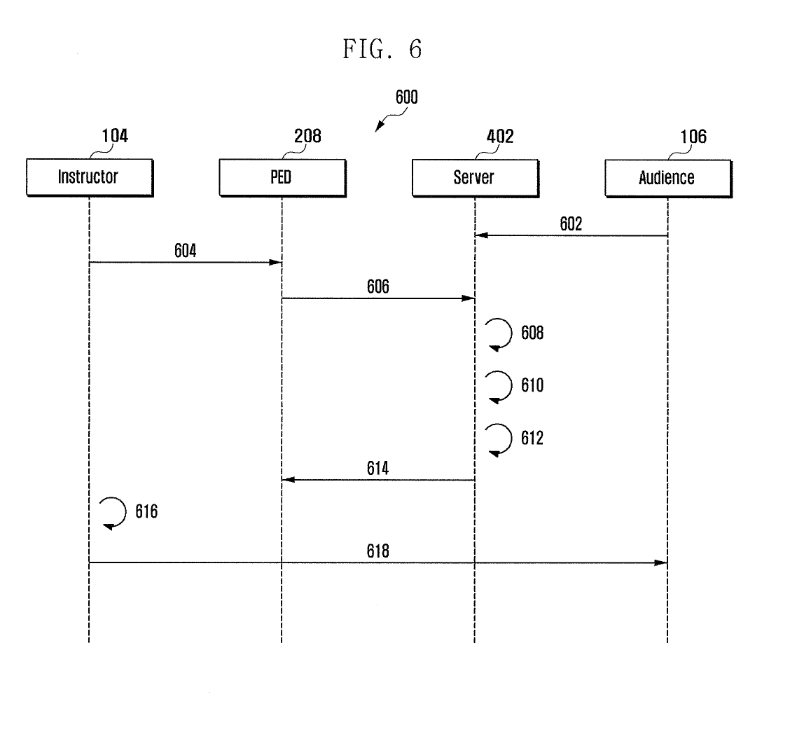

In an example, multiple images can be continuously sent to the server 402 as a video stream. Each image generally includes a scene at which the imaging sensor 210 of the PED 208 is pointed. Such scene can include visual representation of the audience, physical items, location coordinates of the audience, or any other object present in the classroom 102. In an embodiment, the instructor 104 sends the captured image to the server 402 for further processing. The operations performed by the system 400 to provide augmented reality environment using the server 402 are described in conjunction with FIG. 6.

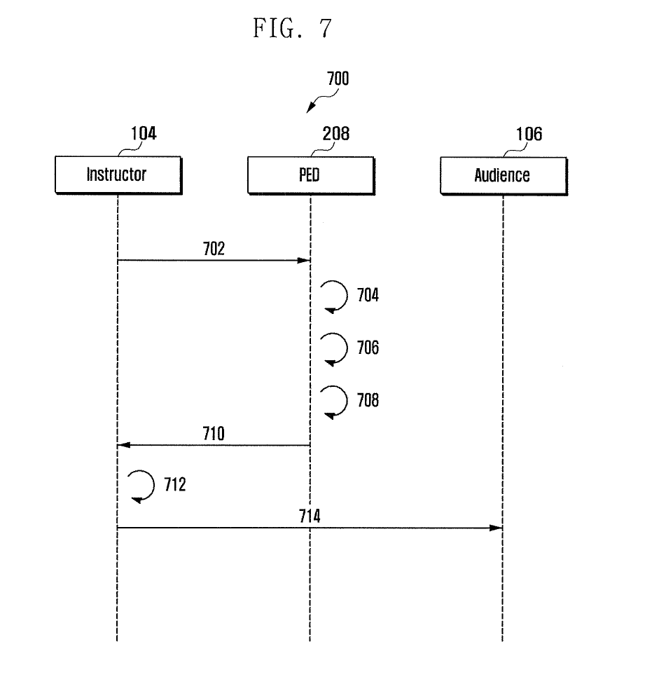

In an embodiment, the PED 208 creates an image in memory of the PED 208 and uses the image for further processing without sending the image to the server 204. The operations performed by the system 400 to provide the augmented reality environment, without using the server 402, is described in conjunction with FIG. 7.

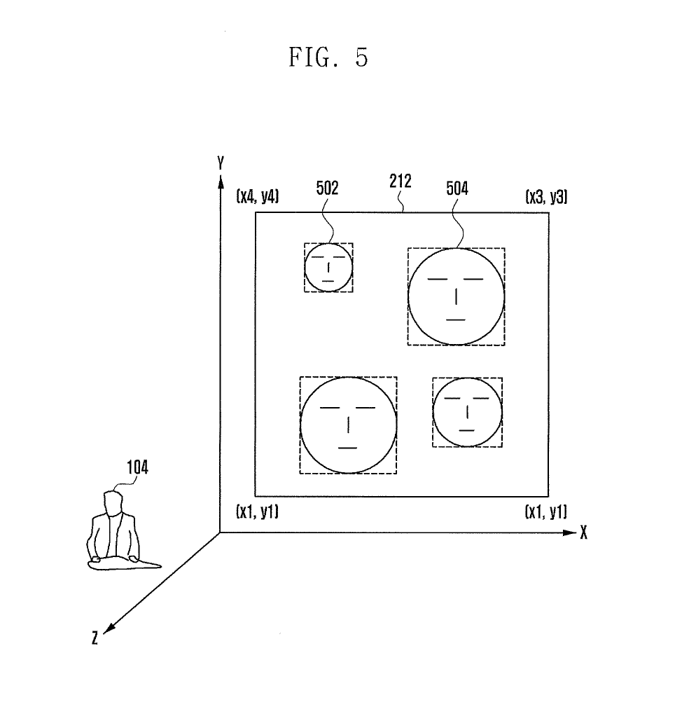

FIG. 5 illustrates generally, among other things, an exemplary predetermined region 212 or field of view of the FIG. 2, according to embodiments as disclosed herein. The use of a common coordinates can assist in presenting the captured image to the instructor 104 for providing an interactive augmented reality environment. The coordinates (x1, y1), (x2, y2), (x3, y3), and (x4, y4) can define the predetermined region 212 that is adjusted, by the instructor 104, according to the position of the audience 106. In an embodiment, the server 402 is configured to perform a facial recognition function on the image to determine face portion 502 of the audience 106. In an example, the server 402 determines the location of the audience 106 by deriving the location coordinates of each individual audience in the image. The server 402 determines that the audience 106 is at point 504 facing towards the instructor 104. The server 402 is configured to determine the position of audience 106 relative to axes of the coordinates, such as axes x, y, and z illustrated as a part of the system 400. In an embodiment, the PED 208 can also determine the location of the audience 106 by using local coordinates, Global Positioning System (GPS) coordinates of the PED 106, or any other technology known in the art.

FIG. 6 illustrates a sequence diagram 600 for operations performed by the system 400 of the FIG. 4 using the server 402, according to embodiments as disclosed herein. In an embodiment, at 602, the audience 106 can provide profile information (or recognition information) for requesting registration of the recognition information with the server 402. Although such registration is not required in other embodiments. In an embodiment, the instructor 104 can also provide the recognition information associated with the audience 106 to the server 402. In an embodiment, the instructor 104 can also register the audience instantly based on the instructor knowledge. Further, the instructor 104 can perform functions to correct/modify or delete the recognition information associated with the audience 106. The server 402 is configured to record the profile information in one or more databases.

At 604, the instructor 104 can use the PED 208 to capture an image of the audience 106. In an example, the instructor 104 can adjust the position of the PED 208 in a way that the audience 106 is within the predetermined region 212 of the imaging sensor 210. In an example, the instructor 104 adjusts the position of the PED 208 according to the position of the audience 106 such that face of every individual in the audience 106 can be clearly visible in the image.

At 606, the instructor 104 can use the PED 208 to send the image to the server 402 through the communication network 404. In an embodiment, the PED 208 can process the image without sending to the server 402 as described in the FIG. 7. At 608, the server 402 is configured to perform facial recognition functions on the image to recognize the audience 106 in the image. The facial recognition functions described herein are any facial recognition functions or techniques known in the art used to determine the facial portions of the audience 106. In an example, the server 402 is configured to recognize the audience 106 by authenticating the determined face portions with the data stored in the database.

At 610, the server 402 is configured to fetch the information associated with the recognized audience 106. In an example, the information extracted by the server 402 can include the profile information, previous records, field information, or any other information. At 612, the server 402 is configured to determine location of the audience 106 in the image. In an example, the server 402 derives the location coordinates of the audience 106 using the standard location, coordinate systems known in the art. At 614, the server 402 is configured to provide the information associated with the recognized audience 106 and determined location coordinates of the audience 106 to the PED 208 through the communication network 404.

In an embodiment, at 616, the instructor 104 can map the information with the determined location of the audience 106. In addition, the instructor 104 can use the information to take attendance, view previous records, manipulate information, or to perform any other action. At 618, the instructor 106 can communicate with the audience 106 based on the mapped information. In an example, an interactive user interface is displayed on the PED 208 of the instructor 104 to transfer data to the audience 106. The instructor 104 can use the interactive user interface to transfer or manipulate digital information to the audience 106, through the communication network 404, by dragging and dropping the digital information in the location coordinates of the audience 106. In an example, the instructor 104 can perform an adaptive communication with the audience 106 based on the information received from the server 402.

FIG. 7 illustrates a sequence diagram 700 for operations performed by the system 400 of the FIG. 4, without using the server 402, according to embodiments as disclosed herein. In an embodiment, at 702, the instructor 104 can use the PED 208 to capture an image of the audience 106. In an example, the instructor 104 can adjust the position of the PED 208 in a way that the audience 106 is within the predetermined region 212 of the imaging sensor 210. In an example, the instructor 104 adjusts the position of the PED 208 according to the position of the audience 106 such that face of every individual in the audience 106 can be clearly visible in the image.

At 704, the PED 208 is configured to create an image in internal memory and perform a facial recognition function on the image to recognize the audience 106. The PED 208 can determine the facial portions and recognizes the audience 106 by authenticating the determined face portions with the data stored in the internal memory. At 706, the PED 208 is configured to fetch the information associated with the recognized audience 106. At 708, the server 402 is configured to determine location of the audience 106 in the image. In an example, the server 402 derives the location coordinates of the audience 106 using the local coordinate system or GPS coordinate system of the PED 208.

At 710, the PED 208 is configured to display the information and determined location coordinates of the audience 106. In an example, the PED 208 provides an interactive user interface to the instructor 104 to transfer digital information to the audience 106. At 712, the instructor 104 can map the information with the determined location coordinates of the audience 106. In an example, the instructor can use the information to take attendance, view previous records, manipulate information, or to perform any other action.

At 714, the instructor 106 can communicate with the audience 106 based on the mapped information. In an example, the instructor 104 can use the interactive user interface to transfer or manipulate any digital information to/from the audience 106 by dragging and dropping the digital information in the location coordinates of the audience 106. In an example, the instructor 104 can perform an adaptive communication with the audience 106 based on the information displayed on the PED 208.

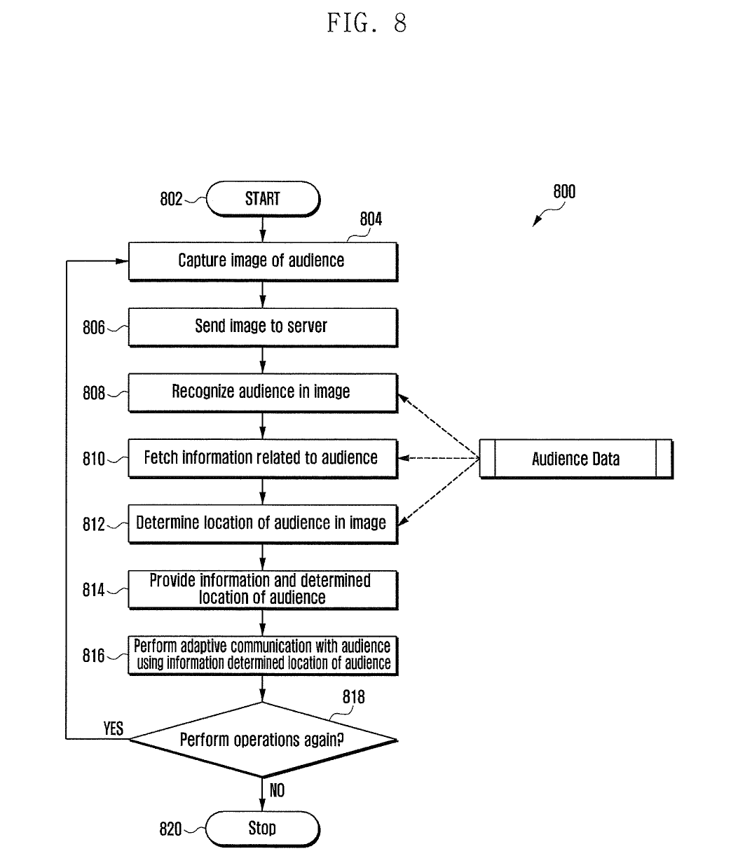

FIG. 8 illustrates a flowchart 800 of a method for providing augmented reality environment, according to embodiments as disclosed herein. Various steps of the flowchart 800 are provided in blocks, where the steps are performed by the instructor 106, the PED 208, the server 402, and a combination thereof. The flowchart 800 starts at step 802. At step 804, the method includes capturing image of the audience 106. In an example, the instructor 104 uses the PED 208 to capture an image of the audience 106. The instructor 104 adjusts the position of the PED 208 in a way that the audience 106 is within the predetermined region 212 of the imaging sensor 210 and face of every individual in the audience 106 is clearly visible in the image.

At step 806, the method includes sending the image to the server 402. In an example, the instructor 104 uses the PED 208 to send the image to the server 402 through the communication network 404. In an example, the instructor 104 uses the PED 208 to further process the image without sending the image to the server 402. At step 808, the method includes recognizing the audience 106 in the image. In an example, the server 402 performs a facial recognition function on the image to determine the face portion of the audience 106. The server 402 recognizes the audience 106 by authenticating the determined face portions with the audience data stored in the database.

At step 810, the method includes fetching information related to the audience 106. In an example, the server 402 fetches the information associated with the recognized audience 106 from the audience data stored in the database. At step 812, the method includes determining location of the audience 106 in the image. In an example, the server 402 derives the location coordinates of the audience 106 using the standard location coordinate systems.

At step 814, the method includes providing the information and determined location of audience 106. In an example, the server 402 provides the determined location and the information associated with the audience 106 to the PED 208 through the communication network 404. At step 816, the method includes performing an adaptive communication with the audience 106 using the information and the determined location of the audience 106. In an example, the instructor 104 transfers the digital information to the audience 106 by dragging and dropping the digital information in the location coordinates of the audience 106. In an example, the instructor 104 communicates with the audience 106 by mapping the received information with the determined location of the audience 106. At step 818, if the instructor 104 wants to perform the operation again, then the method includes repeating the steps 804-818, else the flowchart 800 stops at step 820.

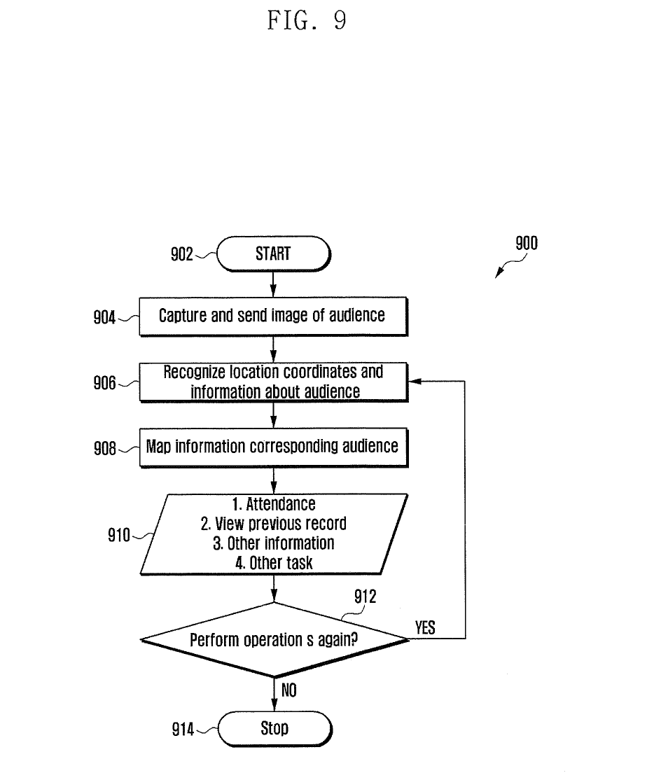

FIG. 9 depicts a flowchart 900 illustrating operations performed by the instructor 104, according to embodiments as disclosed herein. The flowchart 900 starts at step 902. At step 904, the instructor 104 captures and sends an image to the server 402. In an example, the instructor 104 uses the PED 208 to capture the image of the audience 106 and send the image to the server 402 over the communication network 404. At step 906, the instructor 104 receives the location and information about the audience 106. In an example, the server 402 recognizes the audience 106 and fetches the information associated with the recognized audience. In an example, the server 402 determines the location coordinates of the audience 106 in the image. Further, the server 402 sends the location coordinates and the information associated with the audience 106 to the instructor 104. The instructor 106 uses the PED 208 to receive the location coordinates and the information about the audience 106 through the communication network 408.

At step 908, the instructor 104 communicates with the audience 106 by mapping the received information with the corresponding location coordinates of the audience 106. At step 910, the instructor 104 uses the received information to take attendance, view previous records, manipulate information, or to perform any other task in the classroom or any other gathering. At step 912, if the instructor 104 wants to perform the operations again, then the steps 904-912 of the flowchart 900 is repeated, else the flowchart 900 stops at step 914.

The various steps described with respect to the FIGS. 6-9 can be performed in sequential order, in random order, simultaneously, parallel, or a combination thereof. Further, in some embodiments, some of the steps can be omitted, skipped, or added without departing from the scope of the disclosure.

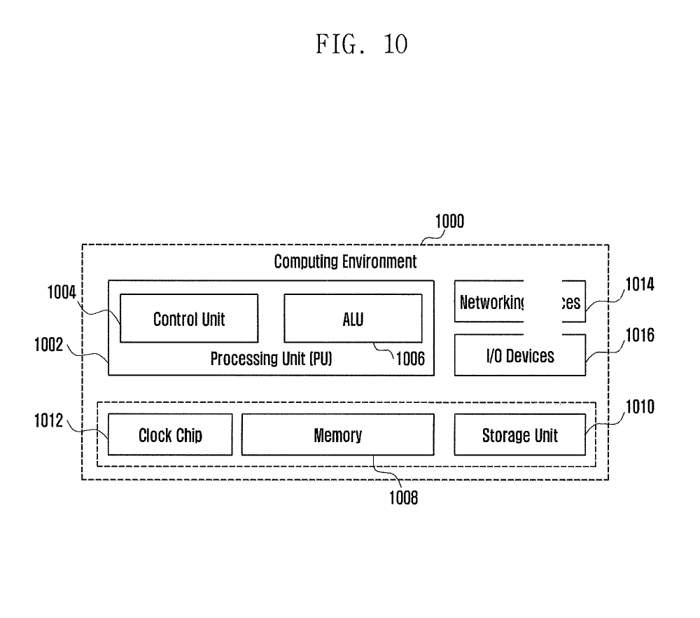

FIG. 10 depicts a computing environment 1000 implementing the application, in accordance with various embodiments of the present disclosure. For example, the computing environment 1000 may be implemented in the PID 208 or the server 402. As depicted, the computing environment 1000 comprises at least one processing unit 1002 that is equipped with a control unit 1004 and an Arithmetic Logic Unit (ALU) 1006, a memory 1008, a storage unit 1010, a clock chip 1012, plurality of networking devices 1014, and a plurality Input output (I/O) devices 1016. The processing unit 1002 is responsible for processing the instructions of the algorithm. The processing unit 1002 receives commands from the control unit 1004 in order to perform processing. Further, any logical and arithmetic operations involved in the execution of the instructions are computed with the help of the ALU 1006.

The overall computing environment can be composed of multiple homogeneous and/or heterogeneous cores, multiple CPUs of different kinds, special media and other accelerators. Further, the plurality of processing units may be located on a single chip or over multiple chips.

The algorithm comprising of instructions and codes required for the implementation are stored in either the memory 1008 or the storage unit 1010 or both. At the time of execution, the instructions may be fetched from the corresponding memory 1008 and/or storage unit 1010, and executed by the processing unit 1002. The processing unit 1002 synchronizes the operations and executes the instructions based on the timing signals generated by the clock chip 1012. The embodiments disclosed herein can be implemented through at least one software program running on at least one hardware device and performing network management functions to control the elements. The elements shown in the FIGS. 1-10 include various units, blocks, modules, or steps described in relation with methods, processes, algorithms, or systems of the present disclosure, which can be implemented using any general purpose processor and any combination of programming language, application, and embedded processor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing an augmented reality based environment using a portable electronic device, the method comprising:
capturing an image of at least one user;
recognizing the at least one user in the image;
fetching information associated with the at least one recognized user;
determining a location of the at least one user in the image;
mapping the fetched information associated with the at least one user with the determined location of the at least one user; and
communicating with the at least one user based on the mapping.

2. The method of claim 1, further comprising adjusting a position of the portable electronic device according to position of the at least one user.

3. The method of claim 2, wherein the position of the portable electronic device is adjusted in accordance to a predetermined region.

4. The method of claim 1, further comprising sending the image to a server for recognition of the at least one user.

5. The method of claim 1, wherein recognizing the at least one user comprises:
performing a facial recognition function on the image to determine face portion of the at least one user; and
authenticating the determined face portion in the image to recognize the at least one user.

6. The method of claim 1, wherein determining the location of the at least one user comprises deriving location coordinates of the at least one user in the image.

7. The method of claim 1, further comprising transferring digital information to the at least one user using the information and the determined location of the at least one user.

8. The method of claim 7, wherein the digital information is transferred by dragging and dropping the digital information in the determined location of the at least one user.

9. The method of claim 1, further comprising using the information and the determined location of the at least one user to take attendance of the at least one user in the environment.

10. The method of claim 1, further comprising performing an adaptive communication with the at least one user based on the fetched information.

11. A system capable of providing an augmented reality based environment, the system comprising:
a portable electronic device configured to capture an image of at least one user;
a processing unit configured to recognize the at least one user in the image, fetch information associated with the at least one recognized user, determine a location of the at least one user in the image, and map the fetched information associated with the at least one user with the determined location of the at least one user; and
a communication unit configured to communicate with the at least one user based on the mapping.

12. The system of claim 11, wherein a position of the portable electronic device is adjusted according to position of the at least one user.

13. The system of claim 12, wherein the position of the portable electronic device is adjusted in accordance to a predetermined region.

14. The system of claim 11, wherein the communication unit is configured to send the image to a server for recognition of the at least one user.

15. The system of claim 11, wherein to recognize the at least one user, the processing unit is configured to perform a facial recognition function on the image to determine face portion of the at least one user, and authenticate the determined face portion in the image to recognize the at least one user.

16. The system of claim 11, wherein to determine the location of the at least one user, the processing unit is configured to derive location coordinates of the at least one user in the image.

17. The system of claim 11, wherein the communication unit is configured to transfer digital information to the at least one user using the information and the determined location of the at least one user.

18. The system of claim 17, wherein the digital information is transferred by dragging and dropping the digital information in the determined location of the at least one user.

19. The system of claim 11, wherein the processing unit is configured to use the information and the determined location of the at least one user to take attendance of the at least one user in the environment.

20. The system of claim 11, wherein the communication unit is configured to perform an adaptive communication with the at least one user based on the fetched information.
